(19) United States
(12) Patent Application Publication
(10) Pub. No.: US 2022/0151218 A1
(43) Pub. Date: May 19, 2022

(54) TRAPPING ASSEMBLY

(71) Applicant: Tyrone Davis, Red Hill (AU)

(72) Inventor: Tyrone Davis, Red Hill (AU)

(21) Appl. No.: 17/525,210

(22) Filed: Nov. 12, 2021

(30) Foreign Application Priority Data
Nov. 13, 2020 (AU) 2020904167
Jun. 29, 2021 (AU) 2021901961

(51) Int. Cl. A01M 23/18; A01M 23/08

(52) U.S. Cl. CPC A01M 23/18; A01M 23/08

(57) ABSTRACT

The present invention resides in a trapping assembly for capturing an animal, the trapping assembly comprising, an enclosure defined by a base, side walls, a rear wall, and a front wall provided with an opening, a stop plate extending from the opening into the enclosure, at least one pivotable gate connected to the front wall and biased to abut the stop plate. The present invention alleviates on or more issues associated with the presently available trapping assemblies and/or provides the consumer with a commercial alternative.

### REFERENCE TO RELATED APPLICATIONS

This application claims priority to Australian Application No. 2020904167, filed Nov. 13, 2020 and Australian Application No. 2021901961, filed Jun. 29, 2021, the entire content of both of which is incorporated herein by reference.

### FIELD OF THE INVENTION

The present invention relates to the field of wildlife management. More particularly, the invention relates to a trapping assembly. Even more particularly, the invention relates to a trapping assembly for capturing an animal.

### BACKGROUND TO THE INVENTION

Any reference to background art herein is not to be construed as an admission that such art constitutes common general knowledge in Australia or elsewhere.

Wildlife are trapped in many parts of the world for a variety of purposes. For instance, wildlife may be trapped to remove predatory animals from a given area, for food, for relocation and/or for research purposes.

For larger animals, large traps are required to ensure that they have sufficient capacity to trap said animal. However, a problem associated with these traps is that they can be cumbersome to transport and install. Furthermore, some traps have electronic equipment that require substantial set up or require the traps to be transported as being fully set up.

It should be appreciated that it would advantageous to address one or more of the above issues or to at least provide a commercial alternative to the consumer.

### SUMMARY OF THE INVENTION

In a first aspect, although it need not be the only or indeed the broadest aspect, the invention resides in a trapping assembly for capturing an animal, the trapping assembly comprising:

an enclosure defined by a base, side walls, a rear wall, and a front wall provided with an opening;

a stop plate extending from the opening into the enclosure;

at least one pivotable gate connected to the front wall and biased to abut the stop plate.

In an embodiment, the trapping assembly comprises a pair of side walls.

In one embodiment, the base is pivotable connected to the side walls, the rear wall and the front wall.

In embodiments, the trapping assembly comprises two or more pivotable gates. In one embodiment, the trapping assembly comprises two pivotable gates adapted to abut the stop plate.

In some embodiments, the at least one pivotable gate is pivotable connected to the front wall. In an embodiment, the at least one pivotable gate abuts a distal end of the stop plate.

In embodiments, the stop plate is generally centrally located in the opening. In one embodiment, the stop plate is perpendicular to the plane of the front wall.

In an embodiment, the trapping assembly is a collapsible trapping assembly. In one embodiment, the trapping assembly is dis-assembable.

In one embodiment, the trapping assembly further comprises a top. In one embodiment, the top is releasably attachable to the side walls, rear wall and front wall.

In one embodiment, the pivotable gate is biased by a biasing device. In embodiments, the biasing device is spring loaded.

In an embodiment, the trapping assembly further comprises a cover adapted to cover an uncovered area defined by the stop plate, the at least one pivotable gate and front wall. The cover is adapted to releasable connect to the stop plate and the front wall.

In some embodiments, the rear wall, side walls, front wall and base are connected to one another.

In an embodiment, the rear wall, side walls, front wall and base each comprise a connecting portion and/or reciprocal connecting portion. The reciprocal connecting portion is complementary to the connecting portion. The connecting portion and respective reciprocal connecting portion are adapted to maintain the orientation of the respective walls.

In another aspect, the invention resides in an assembly for a housing comprising:

a stop plate adapted to extend from an opening of the housing into an enclosure of the housing;

at least one pivotable gate adapted to be connected to the housing, wherein the at least one pivotable gate is biased to abut the stop plate.

The stop plate and the at least one pivotable gate is as substantially described hereinabove.

In a second aspect, the invention resides in a method of capturing an animal, the method including steps of:

providing a trapping assembly comprising an enclosure defined by a base, side walls, a rear wall, and a front wall provided with an opening, a stop plate extending from the opening into the enclosure, at least one pivotable gate connected to the front wall and biased to abut the stop plate;

allowing an animal to enter the enclosure through one pivotable gate, to thereby capture the animal.

The trapping assembly and components thereof may be as substantially described hereinabove.

In an embodiment, the method may further include the step of assembling the trapping assembly. In this regard, the trapping assembly may be assembled by pivoting the walls around a hinge and maintaining the orientation of the wall relative to the base.

The method may further include the step of disassembling the trapping assembly.

The various features and embodiments of the present invention referred to in the individual sections above and in the description which follows apply, as appropriate, to other sections, mutatis mutandis. Consequently features specified in one section may be combined with features specified in other sections as appropriate.

Further features and advantages of the present invention will become apparent from the following detailed description.

### BRIEF DESCRIPTION OF THE DRAWINGS

To assist in understanding the invention and to enable a person skilled in the art to put the invention into practical effect, embodiments of the invention will be described by way of example only with reference to the accompanying drawings, in which:

FIG. 1 shows one embodiment of a trapping assembly;

FIG. 2 shows an enlarged view of a connection between a rear wall and a side wall;

FIG. 3 shows an enlarged view of a hinge connecting a base to the rear wall;

FIG. 4 shows an enlarged view of the connection between a pivotable gate and a front wall;

FIG. 5 shows an enlarged view of a connection between a stop plate and the base;

FIG. 6 shows an enlarged view of the connection between the stop plate and the base at the opening;

FIG. 7 shows an enlarged view of the connection between the stop plate and the front wall;

FIG. 8 shows a cover over an uncovered area;

FIG. 9 shows the connection between the cover and the stop plate;

FIG. 10 shows the connection between the cover and the front wall;

FIG. 11 shows an exemplary flow diagram of disassembling the trapping assembly;

FIG. 12 shows the trapping assembly in the folded configuration;

FIG. 13 shows another embodiment of the trapping assembly; and

FIG. 14 shows the top of the embodiment shown in FIG. 13.

### DETAILED DESCRIPTION OF THE INVENTION

Embodiments of the present invention reside primarily in a trapping assembly. Accordingly, the assembly and method steps have been illustrated in concise schematic form in the drawings, showing only those specific details that are necessary for understanding the embodiments of the present invention so as to not obscure the disclosure with excessive detail that will be readily apparent to those of ordinary skill in the art having the benefit of the present description.

In this specification, adjectives such as first and second, top and bottom, and the like may be used solely to distinguish one element or action from another element or action without necessarily requiring or implying any actual such relationship or order.

Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

As used herein, the term ‘about’ means the amount is nominally the number following the term ‘about’ but the actual amount may vary from this precise number to an unimportant degree.

The present invention is predicated on the finding that a trapping assembly can be easily assembled and disassembled, and is effective in trapping or confining livestock or animals.

In a first aspect, although it need not be the broadest or indeed the only aspect, the invention resides in a trapping assembly for capturing an animal, the trapping assembly comprising:

an enclosure defined by a base, side walls, a rear wall, and a front wall provided with an opening;

a stop plate extending from the opening into the enclosure;

at least one pivotable gate connected to the front wall and biased to abut the stop plate.

Shown in FIG. 1 is a trapping assembly 100 for capturing an animal. The trapping assembly 100 comprises an enclosure 105 defined by a base 110, side walls, a rear wall 130 and a front wall 140. In the embodiment shown, the trapping assembly 100 comprises a pair of side walls 120a, 120b. The base 110 is connected to the rear wall 130, front wall 140 and pair of side walls 120a, 120b. The front wall 140 is provided with an opening 145. That is the front wall 140 is provided with a void which may act as an entrance for an animal to be trapped. In the embodiment shown, the void is formed at a lower end of the front wall 140. That is, in use, the entrance is located near the ground.

The trapping assembly 100 further comprises a stop plate 160. The stop plate 160 extends from the opening 145 into the enclosure 105. The stop plate 160 is suitably releasably attached to the front wall 140. The trapping assembly 100 further comprises at least one pivotable gate. The at least one pivotable gate is suitably connected to the front wall 140 and biased to abut the stop plate 160. In the embodiment shown, the trapping assembly 100 comprises a pair of pivotable gates 170a, 170b. As shown, the pair of pivotable gates 170a, 170b are pivotably connected to the front wall 140. In a rest state, as shown, the pivotable gates 170a, 170b are biased such that they abut the stop plate 160. Preferably, the pivotable gates 170a, 170b abuts the stop plate 160 adjacent an end thereof. Preferably, the pivotable gate 170a, 170b abuts the stop plate 160 towards the end in the enclosure. The abutment of the pivotable gate 170a, 170b to the stop plate 160 away from the end thereof advantageous alleviates the issue of a captured animal from opening the gate and escaping from the enclosure 105.

In use, the trapping assembly 100 is placed in the vicinity of the animal to be captured. Bait may be placed in the trapping assembly 100 such that the animal can push one of the pivotable gates to gain access to the enclosure 105 and bait therein. Once within the enclosure 105, the pivotable gate 170a/170b engages the stop plate 160 to prevent the captured animal from being released from the enclosure.

In one embodiment, the trapping assembly may comprise one or more stop plates. In this regard, each of the at least one pivotable gates may be biased to a respective stop plate. Alternatively, the at least one pivotable gates may be biased to engage the same stop plate.

In one embodiment, the trapping assembly may further comprise a top. The top is suitably releasably connectable to the rear wall, front wall and side walls. It will be appreciated that the top need not be essential to the invention. In this regard, as long as the rear wall, side walls and front wall are of sufficient height that an animal cannot escape therefrom then a top is not necessarily required. However, it will be appreciated that a top may be provided for an additional deterrent.

The base 110 may comprise a plurality of connecting portions at each end thereof. Each of the rear wall, side walls and front wall may comprise a reciprocal connecting portion at a bottom end thereof. The reciprocal connecting portion are each complementary to each of the connecting portions of the base. The side walls may further comprise additional connecting portions at side ends thereof. The front and rear walls may further comprise additional reciprocal connecting portions at side ends thereof. The additional connecting portions are complementary to the additional reciprocal connecting portions. It will be appreciated that the connecting portions and reciprocal connecting portions secure the walls to each other and the base to form a stable structure that defines the enclosure.

The top may similarly comprises a plurality of connecting portions at each end thereof. Each of the rear wall, side walls and front wall may comprise a reciprocal connecting portion at a top end thereof.

In one embodiment, the connecting portion and reciprocal connecting portion may together be formed of a pin system that maintains the orientation of adjacent walls. In this regard, the connecting portion may comprise a pin system that holds the connecting portion in a substantially fixed position relative to the reciprocal connecting portion. Thus, the orientation of the walls are substantially fixed by the connecting portion and reciprocal connecting portion. In one embodiment, the side walls, front wall and rear wall are substantially perpendicular to the base.

The assembly may further comprise a support portion(s) which assist in holding the assembly. In one embodiment, the support portion suitably comprises a brace. The support portion may suitably be formed with, or fixed with, the base. In an embodiment, the support portion suitably comprises an upright portion which may engages the side walls and prevents them from proceeding beyond a certain angle. In one embodiment, the upright portion is perpendicular to the plane of the base. The support portion or brace may be integrally formed with the base or may be attached therewith. The support portion also protects the assembly when in the folded or closed configuration (mentioned in more detail hereinafter).

In one embodiment, a side wall is suitably connected the base via the support portion. In this embodiment, the side wall may be hingedly connected to the support portion.

The support portion on an outer end thereof may further comprise an attachment portion. The attachment portion may be in the form of a hinged aperture which can facilitate lifting (such as by a crane).

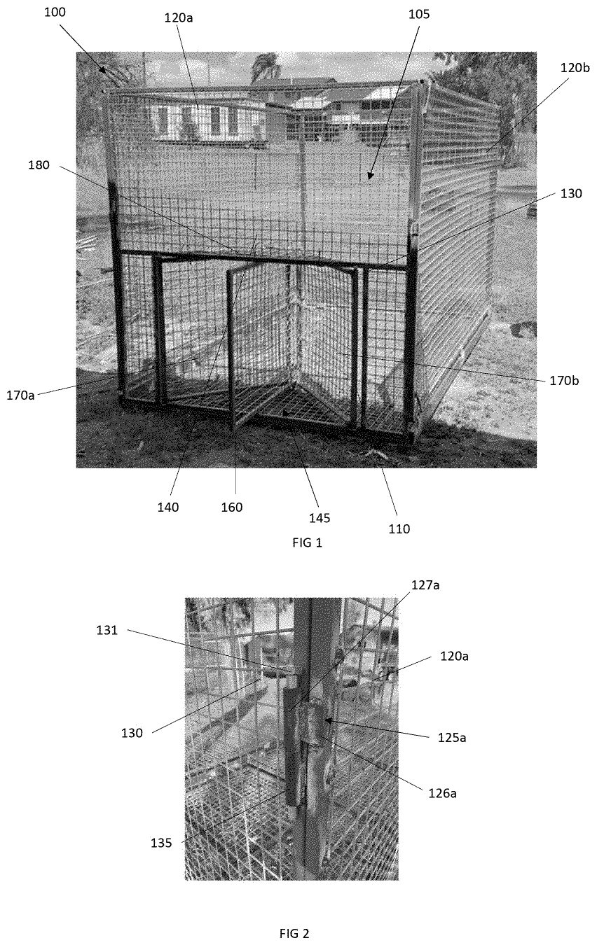

Shown in FIG. 2 is an enlarged view of the connecting portion and the reciprocal connecting portion between the rear wall 130 and the side wall 120a. The side wall 120a comprises a connecting portion 125a. The connecting portion 125a is affixed to the side wall 120a. The connecting portion 125a comprises an affixed portion 126a. The affixed portion 126a is suitably welded to an end of the side wall 120a. The connecting portion 125a comprises a retaining portion 127a comprising a bore (not shown) therein. The retaining portion 127a is in a fixed orientation to the affixed portion 126a. The rear wall 130 comprises the reciprocal connecting portion 135. The reciprocal connecting portion 135 is affixed to the rear wall 130. The reciprocal connecting portion 130 is suitably welded to an end of the rear wall 130. The reciprocal connecting portion 135 comprises a body having a bore (therein) therein. In use, the bore of the reciprocal connecting portion 135 is aligned with the bore of the connecting portion 125a. As shown, an elongate member (such as a pin 131) may be inserted through the aligned bores to maintain the orientation of the rear wall 130 and side wall 120a. The person skilled in the art will appreciate that the connecting portion and reciprocal connecting portion may be interchangeable with one another. Furthermore, the person skilled in the art will appreciate that the above mechanism only exemplifies one method of retaining the position of one wall relative to another wall and that other known methods can be utilized. In one embodiment, the front wall, rear wall and side walls are perpendicular relative to the base, and optionally perpendicular to the top (if applicable). One or more connecting portions and respective reciprocal connecting portions may be utilized to maintain the orientation of one wall relative to another wall.

In one embodiment, each of the rear wall, side walls and front wall are hingedly connected to the base. In one embodiment, one of the rear wall, side walls and front wall may be hingedly connected to the top. It will be appreciated that the connecting portion and the reciprocal connecting portion are utilized to retain each wall at about perpendicular relatively to one another.

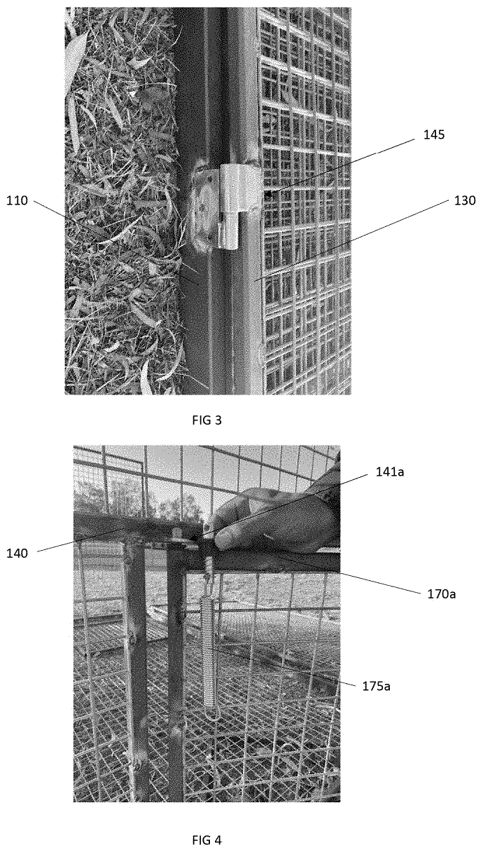

Shown in FIG. 3 is an enlarged view of a hinge connecting the base 110 to the rear wall 130. In the embodiment shown, the hinge 115 is formed between the base 110 and the rear wall 130. The hinge 115 allows the rear wall to be pivoted around an axis defined by the hinge into the desired orientation. Once in the desired orientation (perpendicular to the base), the connecting portion and reciprocal connecting portion (such as that described above) may be utilized to hold this orientation. The person skilled in the art will appreciate this description will be applicable to the other hinges. One or more hinges may be utilized between each wall to facilitate relative pivotable movement.

Shown in FIG. 4 is an enlarged view of the connection between the pivotable gate 170a and the front wall 140. As shown, pivotable gate 170a is connected to the front wall 140 by a pivotable connection 141a. The pivotable gate 170a is similarly connected to the front wall 140 at a lower end thereof by a second pivitable connection (not shown). In one embodiment, the lower end of the pivotable gate 170a may be connected to the base 110 by a second pivotable connection. As shown, the pivotable gate 170a is pivotably connected to the front wall 140 in the opening. The pivotable gate 170a, 170b are suitably pivotably connected to the front wall 140 at a location in the opening towards the pair of side walls 120a, 120b, respectively. The pivotable connection 141a and second pivotable connection define an axis in which the pivotable gate 170a is pivotable.

As mentioned hereinabove, the pivotable gate 170a is biased to abut the stop plate 160. The pivotable gate 170a is suitably biased by a biasing device 175a. The biasing device 175a is suitable removably attachable to the pivotable gate 170a at one end thereof. The biasing device 175a may comprise a spring or tensioning portion. The distal end of the biasing device 175a is suitably removably attachable to the first wall 140 (not shown connected in FIG. 4). The biasing device 175a ensures that the pivotable gate 170a abuts the stop plate 160 at rest (that is, when no force is applied thereto).

Shown in FIG. 5 is an enlarged view of the connection between the stop plate 160 and the base 110. The stop plate 160 is suitably removably retained by the base 110. As shown, the stop plate 160 comprises an aperture (not shown). In the embodiment shown, the stop plate 160 comprises a body 161 comprising the aperture. The base 110 comprises an aperture that aligns with the aperture in the stop plate 160. The base 110 suitably comprises a body 111 which similarly comprises the aperture (not shown). The body is suitably fixed to the base 110. As shown, an elongate member (such as a pin 112) may be inserted into the aligned aperture to retain the stop plate 160 relative to the base 110.

FIG. 6 shows an enlarged view of the connection between the stop plate 160 and the base 110 at the opening. The base 110 comprises an aperture 113 that is adapted to receive a formation 162 formed in the stop plate 160. The formation 162 is suitably accepted in the aperture 162 to maintain the orientation of the stop plate 160 (in conjunction with the previously mentioned connection in FIG. 5) relative to the base 110.

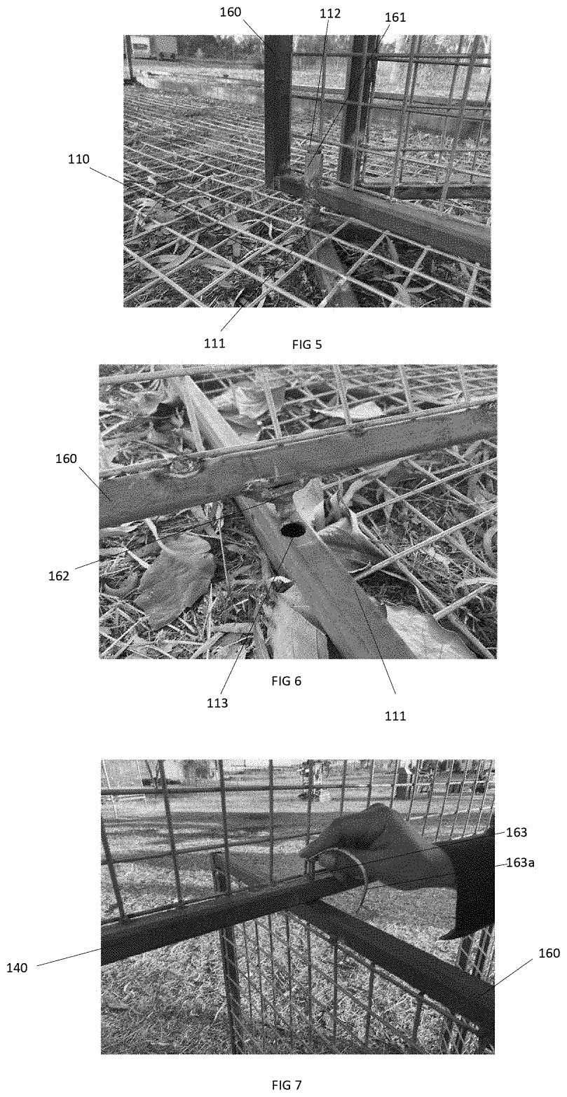

FIG. 7 shows an enlarged view of the connection between the stop plate 160 and the front wall 140. The front wall 140 comprises an aperture (not shown) that is aligned with an aperture (not shown) in the stop plate 160. A retaining device 163 may be inserted into the aligned apertures. The retaining device 163 comprises a holding mechanism 163a that holds the retaining device 163 in place. This alleviates the problem of the retaining device being accidentally dislodged. It should be appreciated that the orientation of the stop plate 160 relative to the base 110 and the front wall 140 is substantially retained in the desired orientation.

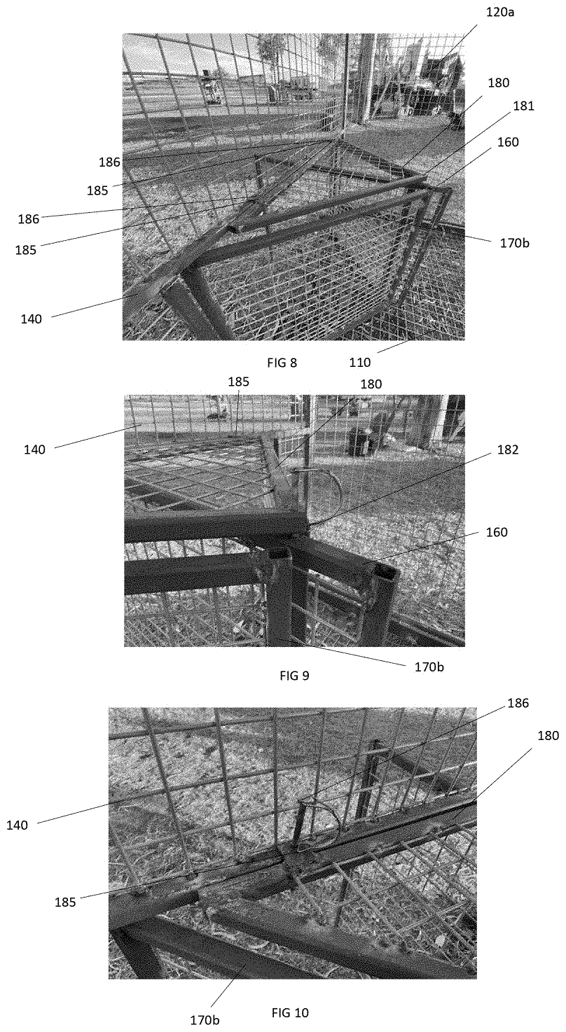

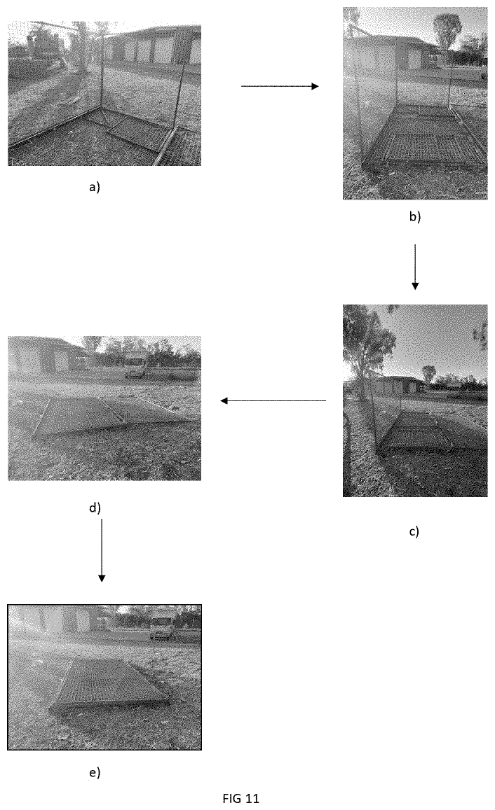

It will be appreciated that the stop plate 160, pivotable gates 170a, 170b and front wall 140 define an uncovered area. In this regard, an uncovered area is formed above the pivotable gates 170a, 170b, stop plate 160 and the front wall 140. In order to stop captured animals from escaping through this uncovered area, a cover 180 is provided (shown in FIG. 8). The cover 180 is releasably attachable to the stop plate 160 (shown in FIG. 9). In this regard, the cover 180 comprises an aperture 181 that is aligned with an aperture (not shown) of the stop plate 160. A retaining member 182 (similar to retaining device 163) may be inserted in the aligned apertures to maintain the position of the cover 180 to the stop plate 160.

The cover 180 may also be releasably attached to the front wall 140. The front wall 140 is suitably adapted to retain the cover 180 in a particular orientation. For instance, the cover 180 suitably comprises a plate portion 185 that comprises an aperture 186. The aperture 186 is suitably aligned with an aperture (not shown) in the front wall 140. A retaining member (such as retaining member 186, similar to retaining device 163) may be inserted into the aligned apertures to retain the position. In this regard, the cover 180 may have multiple plate portions 185 that are adapted to cooperate with a number of apertures of the front wall 140. In the embodiment shown, the cover comprises two plate portions 185. This advantageously allows for the cover to be in a fixed position, and is stable enough to deter captured animals from escaping from the trapping assembly.

Advantageously, the present invention allows for a trapping assembly to be easily assembled, disassembled and transported. In one embodiment, the front wall, side walls and rear walls are hingedly connected to the base. This allows for the trapping assembly to be easily taken down and folded for transport. In this regard, the trapping assembly can be easily assembled by using the connecting portion and reciprocal connecting portion to hold the orientation of the enclosure. The stop plate, pivotable gates and cover can be similarly easily assembled. The trapping assembly can also be easily disassembled, and form a compact folded configuration that can be easily transported. Furthermore, the pivotability of the walls further facilitates ease of assembly.

Alternatively, the present invention may have the front wall, side walls, rear wall, base and/or top fixed together. In one embodiment, the front wall, side walls, rear wall base and/or top fixed to each other by methods known to the person skilled in the art. Non-limiting examples of the fixing method include being clipped together and/or being bolted together. In some embodiments, the present invention may have one or more of the front wall, side walls, rear wall, base and top fixedly attached to one another, and the others may be hingedly connected.

Shown in FIG. 11 is a flow chart of an exemplary method of disassembling the trapping assembly 100 into the folded configuration for transport. In step a), the pivotable gates 170a, 170b, stop plate 160 and cover 180 are disassembled and the front wall 140 and side wall 120a are disengaged. In step b), the pivotable gates 170a, 170b are placed on the base 110 and the front wall 140 pivoted such that it lies thereon. In step c), the rear wall 130 is disengaged and pivoted such that it lies on the front wall 140. In step d), the side wall 120b is disengaged and pivoted such that it lies on the rear wall 140. In step e), the side wall 120a is pivoted such that it lies on the side wall 120b. The person skilled in the art will appreciate that a different order of steps may be taken depending on the trapping assembly.

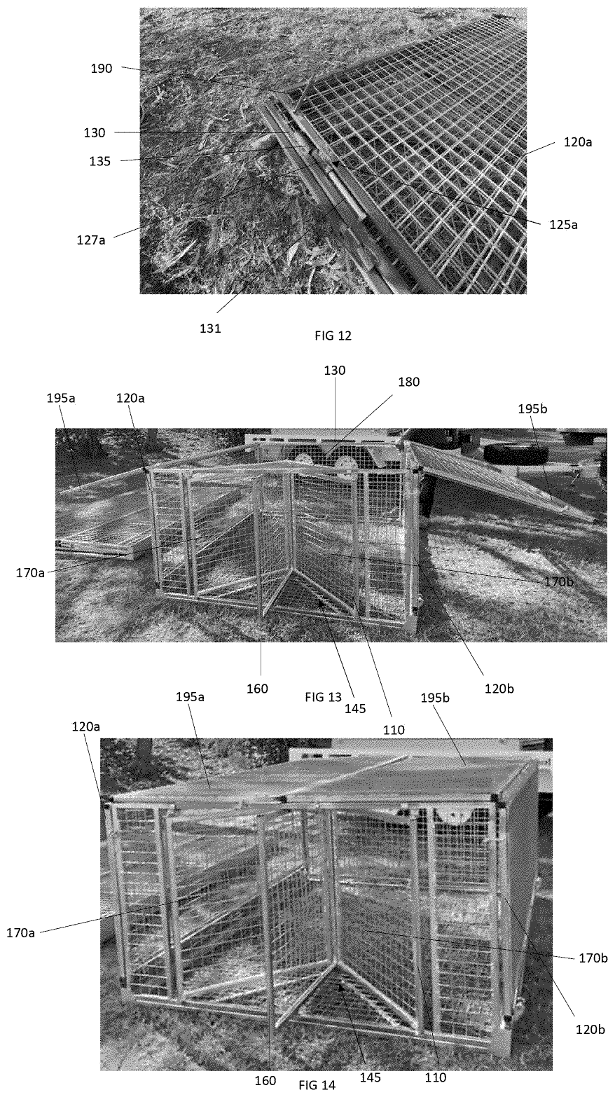

Shown in FIG. 12 is the trapping assembly in the folded configuration. The trapping assembly may suitably be configured to be in an in-use configuration. In this position, a pin (mentioned hereinabove) can be utilized to maintain the trapping assembly in the folded configuration. In this regard, the pin 131 may be inserted into the connecting portion 125a and reciprocal connecting portion 135. This facilitates transport of the trapping assembly. Furthermore, the corners of one or more the side walls, rear wall, front wall and/or base may be provided with a lifting lug 190 so it facilitate lifting (such as by a crane).

In an embodiment, the top is suitably hingedly connected to one or more of the rear wall, front wall and side walls. In some embodiments, the top or roof may be formed of a first top and a second top. In this embodiment, the first top may be hingedly connected to a side wall and the second top may be hingedly connected to another side wall. In this embodiment, the first top and the second top may be suitably secured to the side wall(s) and/or front and rear walls.

Shown in FIG. 13 is a trapping assembly whereby the top is formed of first top hingedly connected to a side wall and the second top is hingedly connected to another side wall. For ease of description, similar reference numerals have been utilized as for the trapping assembly 100. The main difference between the trapping assembly of FIG. 13 and the trapping assembly 100 is the provision of first top 195a hingedly connected to side wall 120a and the second top 195b hingedly connected to side wall 120b. The first top 195a and second top 195b together form the top or roof (as shown in FIG. 13).

It will be appreciated that the provision of the pivotable gates and stop plate may be retrofitted to presently available assemblies or housing. In this regard, in one aspect, the invention resides in an assembly for a housing comprising:

a stop plate adapted to extend from an opening of the housing into an enclosure of the housing;

at least one pivotable gate adapted to be connected to the housing, wherein the at least one pivotable gate is biased to abut the stop plate.

The stop plate and at least one pivotable gate may be as substantially described hereinabove.

The assembly is suitably for use with a housing comprising an opening. The stop plate can be suitably connected to the housing such that it extends from the opening into the enclosure of the housing. The at least one pivotable gate is suitably adapted to be connected to the housing such that the at least one pivotable gate is biased to abut the stop plate.

In one embodiment, the assembly is when used with a housing comprising an opening. In some embodiments, the assembly is for use in capturing an animal. In one embodiment, the assembly is when used in capturing an animal.

In a second aspect, the invention resides in a method of capturing an animal, the method including steps of:

providing a trapping assembly comprising an enclosure defined by base, side walls, a rear wall, and a front wall provided with an opening, a stop plate extending from the opening into the enclosure, at least one pivotable gate connected to the front wall and biased to abut the stop plate;

allowing an animal to enter the enclosure through one pivotable gate, to thereby capture the animal.

The trapping assembly and components thereof may be as substantially described hereinabove.

The method may further include the step of assembling the trapping assembly. In this regard, the trapping assembly may be assembled by pivoting the walls around a hinge and maintaining the orientation of the wall relative to the base.

The method may further include the step of disassembling the trapping assembly.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A trapping assembly for capturing an animal, the trapping assembly comprising:
an enclosure defined by a base, side walls, a rear wall, and a front wall provided with an opening;
a stop plate extending from the opening into the enclosure;
at least one pivotable gate connected to the front wall and biased to abut the stop plate.

2. The trapping assembly of claim 1, wherein the trapping assembly comprises a pair of side walls.

3. The trapping assembly of claim 1, wherein the base is pivotable connected to the side walls, the rear wall and the front wall.

4. The trapping assembly of claim 1, wherein the trapping assembly comprises two pivotable gates adapted to abut the stop plate.

5. The trapping assembly of claim 1, wherein the at least one pivotable gate is biased to the stop plate by a biasing device.

6. The trapping assembly of claim 1, wherein the trapping assembly further comprises a top.

7. The trapping assembly of claim 6, wherein the top is hingedly connected to one of the rear wall, front wall and side walls.

8. The trapping assembly of claim 7, wherein the top comprises a first top and a second top, wherein the first top is hingedly connected to one of the rear wall, front wall and side walls, and the second top is hingedly connected to one of the rear wall, front wall and side walls.

9. The trapping assembly of claim 1, wherein the trapping assembly further comprises a cover adapted to cover an uncovered area defined by the stop plate, the at least one pivotable gate and front wall.

10. The trapping assembly of claim 1, wherein the trapping assembly is configurable between a folded configuration and an in-use configuration.

11. The trapping assembly of claim 1, wherein the rear wall, side walls, front wall and base each comprise a connecting portion and/or reciprocal connecting portion adapted to maintain the orientation of the respective walls.

12. The trapping assembly of claim 1, wherein the trapping assembly further comprises a cover adapted to cover an uncovered area defined by the stop plate, the at least one pivotable gate and front wall.

13. An assembly fora housing comprising:
a stop plate adapted to extend from an opening of the housing into an enclosure of the housing;
at least one pivotable gate adapted to be connected to the housing, wherein the at least one pivotable gate is biased to abut the stop plate.

14. A method of capturing an animal, the method including steps of:
providing a trapping assembly comprising an enclosure defined by a base, side walls, a rear wall, and a front wall provided with an opening, a stop plate extending from the opening into the enclosure, at least one pivotable gate connected to the front wall and biased to abut the stop plate;
allowing an animal to enter the enclosure through one pivotable gate, to thereby capture the animal.
